(19) United States
(12) Patent Application Publication
(10) Pub. No.: US 2010/0327544 A1
(43) Pub. Date: Dec. 30, 2010

(54) Cylinder Cart

(75) Inventors: Richard Allen Pebworth, Wichita Falls, TX (US); Kevin Mark Klughart, Denton, TX (US)

Correspondence Address: KEVIN MARK KLUGHART, 2516 LILLIAN MILLER PARKWAY, SUITE 115, DENTON, TX, 76210-7205, US

(73) Assignee: Richard Allen Pebworth

(21) Appl. No.: 12/459,326

(22) Filed: Jun. 29, 2009

(51) Int. Cl. B62B 1/12; B62B 1/00; B60P 1/02; B62B 5/04

(52) U.S. Cl. 280/6.151

(57) ABSTRACT

A cylinder cart system that incorporates a stabilizing platform for safely loading and offloading of gas/fluid cylinders from trucks and the like is disclosed. The cylinder cart system incorporates a stabilizing platform to which a tank retention mechanism is attached that permits a gas/fluid cylinder to be retrained and raised/lowered via the use of an integrated elevator mechanism that may be manually or power operated. In the raised position, the cylinder cart provides sufficient stability to permit safe offloading of a gas/fluid cylinder onto a pickup truck or the like by a single person. In the lowered position, the cylinder cart incorporates hand truck functionality to permit transport of the gas/fluid cylinder across rugged terrain. An optional integrated safety braking system may in some embodiments provide additional stabilization of the system when the cylinder cart is in the raised position.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to the manual transport of gas/fluid cylinders and the like.

### PRIOR ART AND BACKGROUND OF THE INVENTION

### Overview

The present invention is specifically designed to address several areas of safety concern in the manual transportation of gas/fluid cylinders. These gas/fluid cylinders are often referred to as DOT High Pressure 3AA/4AA cylinders and are used to contain and transport oxygen, argon, air, nitrogen, mixtures, and other compressed gas and fluid applications. These cylinders are manufactured under strict quality control guidelines and are specifically designed for the safe transport of compressed gas and/or fluids. To implement necessary safety margins in the manufacture of these cylinders, wall thickness and subsequent weight of these cylinders can be significant. For example, a 4AA480 cylinder (“XG” style, 15×56 inch) empty might weigh approximately 150 lbs and fully filled with liquid might weigh as much as 425 lbs.

These weights make the manual transportation of these cylinders extremely difficult, as in many cases the transportation must be accomplished without the use of truck tailgate lifts and also must be accomplished with only a single person. In a typical application environment in which a maintenance person is dispatched to a utility substation to deliver switch contactor arc suppression fluid in cylinder tanks, the cylinder is loaded on a pickup truck and must be unloaded onto rugged gravel terrain surrounding the utility station and then transported by one person into the substation facility. Due to the extreme weight of the cylinder tanks, many individuals have difficulty in safely unloading the cylinder tank from the pickup truck, either incurring back injuries attempting to manually unload the cylinder or alternatively accidentally dropping the cylinder onto the ground in their attempt to unload the cylinder from the pickup truck.

### Prior Art

The prior art regarding the use of cylinder carts is well documented. However, conventional cylinder carts as might be used in the welding industry and the like are unable to address the issue of unloading extremely heavy and bulky fluid-filled cylinders from pickup trucks and the line by a single person.

Traditional cylinder carts do not incorporate sufficient stability to transport these cylinders across rugged terrain as might be typically encountered in an electrical power substation. Additionally, the use of conventional cylinder carts and the like in these environments raises a safety issue in that poor stability in conventional hand trucks could cause the cylinder to be dropped, resulting in catastrophic personal and property damage should the cylinder valve be compromised during the accident.

### Deficiencies in the Prior Art

The prior art with respect to cylinder carts suffers from several deficiencies, including but not limited to providing for safe elevation and/or safe unloading of the cylinder onto a truck in situations in which a single person is available for the transportation of the cylinder.

### OBJECTIVES OF THE INVENTION

Accordingly, the objectives of the present invention are (among others) to circumvent the deficiencies in the prior art and affect the following objectives:
(1) Provide for a cylinder cart that permits safe transportation of heavy fluid filled cylinders by a single individual.
(2) Provide a cylinder cart that can operate safely over rugged terrain, as might be encountered at an electrical power substation.
(3) Provide a cylinder cart that permits elevation of a cylinder for safe placement on a truck.
(4) Provide a cylinder cart that permits safe unloading of a cylinder from a truck.
(5) Provide a cylinder cart that is inexpensive and portable.
(6) Provide a cylinder cart that minimizes the possibility of back injury to the operator of the cylinder cart during the transportation of fluid-filled cylinders.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### Overview (0100)

The present invention and typical application is generally illustrated in FIG. 1 (0100) wherein the cylinder cart generally comprises a stabilizing platform (0101) which provides a structure to which a tank retention mechanism (0102) is attached. This tank retention mechanism (0102) is retained within rails (optimally guide channels) contained on the stabilizing platform (0101). Guide rollers on the tank retention mechanism (0102) permit the tank retention mechanism to be elevated within the confines of the stabilizing platform rails. Elevation of the tank retention mechanism (0102) is accomplished via an integrated elevator mechanism (0103) that may be manually or power operated. The present invention incorporates hand rails (0104) and all-terrain tires (0105) to aid in the transportation of the cylinder over rugged terrain, as might be encountered in an electrical power substation. The system may also incorporate a safety braking mechanism (0106) which prevents movement of the cylinder cart when the tank retention mechanism (0102) is elevated.

### General Construction Assembly View (0200)

The present invention can be generally illustrated by the preferred exemplary embodiment illustrated by the assembly view diagram of FIG. 2 (0200). The elements of the present invention generally include the following:
Stabilizing platform (0101) further comprising floor forks (0201) and channel rails (0202) used to guide the tank retention mechanism;
Tank retention mechanism (0102) incorporating a platform (0203) to support the cylinder tank, support rails (0204) to confine the cylinder tank, chain or other restraint (0205) to retain the cylinder tank, and guide rollers (0206) to permit vertical movement of the tank retention mechanism within the channel rails (0202) of the stabilizing platform (0101);
Integrated elevator mechanism (0103) may be operated manually or under power control and generally incorporates a winch (0207) or other lifting device and a cable (0208) and pulley (0209) apparatus to affect lifting of the tank retention mechanism (0102) within the channel rails of the stabilizing platform (0101);
Optional safety brakes (0106) which are activated by lever arms (0210) that ensure the hand truck wheels do not move when the cylinder tank is elevated.

This system as generally illustrated in FIG. 1 (0100) and FIG. 2 (0200) may be constructed of a wide variety of materials. However, a preferred embodiment utilizes steel as the primary construction material, as this material is easily fabricated and possesses the requisite strength to safely support cylinders of extreme weight.

### BRIEF DESCRIPTION OF THE DRAWINGS

For a fuller understanding of the advantages provided by the invention, reference should be made to the following detailed description together with the accompanying drawings wherein:

FIG. 1 illustrates a preferred exemplary embodiment of the present invention;

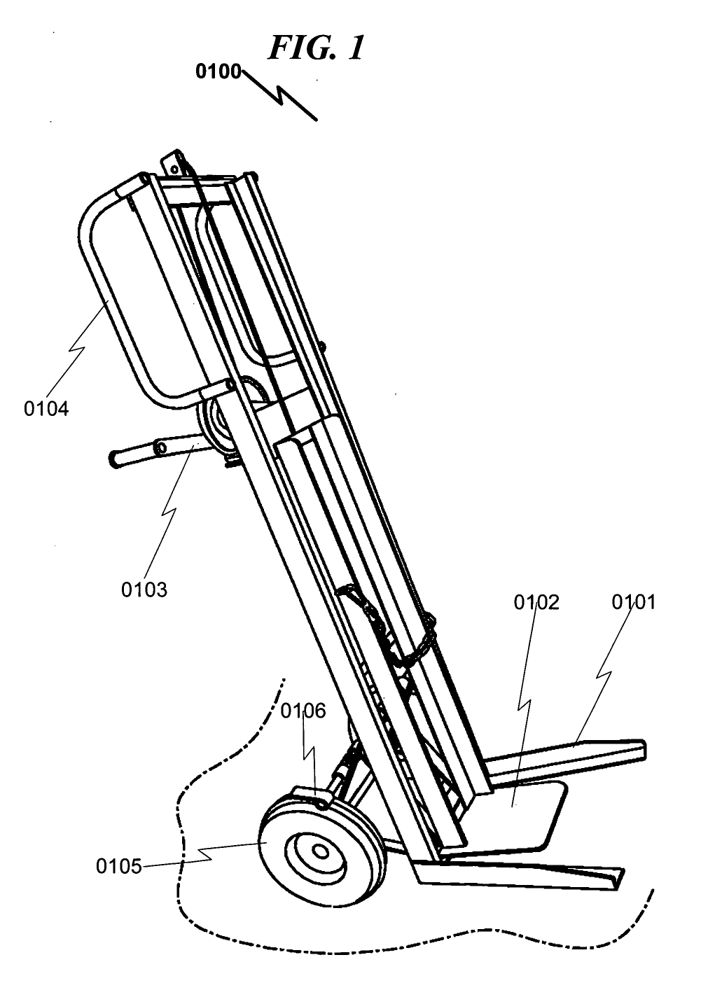

FIG. 2 illustrates an assembly view of a preferred exemplary embodiment of the present invention;

FIG. 3 illustrates a front view of a preferred exemplary embodiment of the present invention;

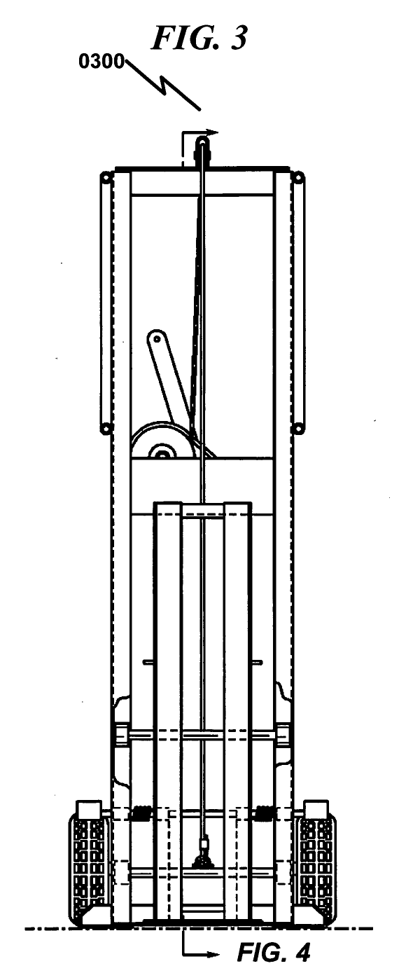

FIG. 4 illustrates a side view of a preferred exemplary embodiment of the present invention;

FIG. 5 illustrates a back view of a preferred exemplary embodiment of the present invention;

FIG. 6 illustrates a top view of a preferred exemplary embodiment of the present invention;

FIG. 7 illustrates a typical use view of a preferred exemplary embodiment of the present invention in which the present invention is used to transport a cylinder to the edge of a pickup truck bed in preparation for loading the cylinder onto the pickup truck;

FIG. 8 illustrates a typical use view of a preferred exemplary embodiment of the present invention in which the present invention is used to lift a cylinder to the level of a pickup truck bed;

FIG. 9 illustrates a typical use view of a preferred exemplary embodiment of the present invention in which the present invention is used to transfer a cylinder to the bed of a pickup truck.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a CYLINDER CART. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Materials Not Limitive

The present invention may be constructed of a variety of materials, including but not limited to plastic, metal, wood, etc. Embodiments utilizing mild steel, steel alloys, aluminum, and/or aluminum alloys are known to be satisfactory for many anticipated applications. In particular, aluminum alloys such as 6061-T6 and the like may be particularly applicable in embodiments where low weight, high strength, and resistance to spark generation are desirable. The use of this material significantly reduces the potential for air/fluid explosions generated by steel sparking due to friction with ground cover and gravel, etc. in situations where cylinders have leaked or are transported in environments that are contaminated with potential explosive hazards. The general construction illustrated herein is not intended to limit the scope of materials suitable for this application. One skilled in the art will recognize that the system may be constructed of a wide variety of materials without departing from the scope of the invention as taught herein.

### Integrated Elevator Mechanism (0400)

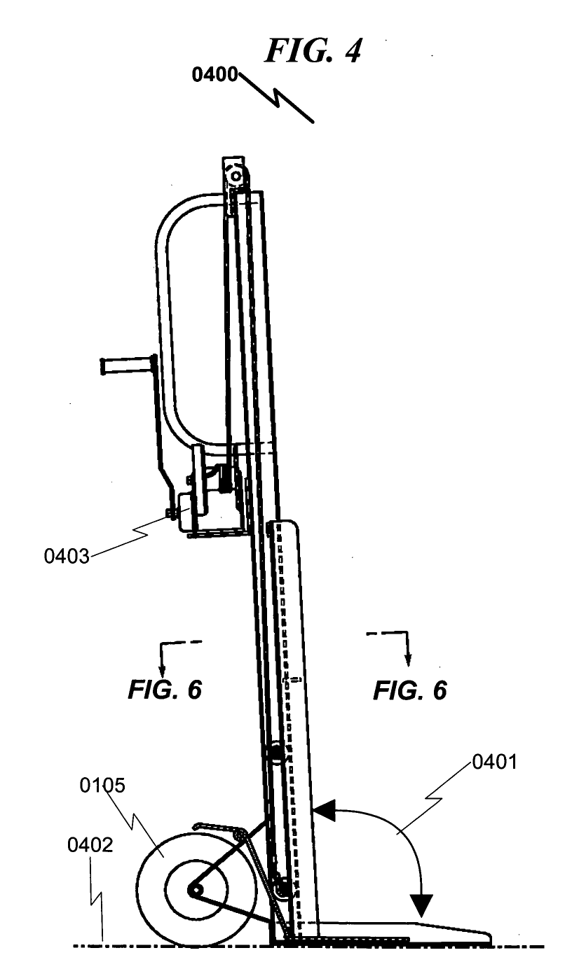

As generally illustrated in FIG. 4 (0400), the cylinder tank retention mechanism is raised via the use of an integrated elevator mechanism. Many preferred embodiments utilize a hand winch (0403) in this application. However, both manual and power operated methods of elevation are anticipated by the present invention. Generally speaking the integrated elevator mechanism should incorporate a braking mechanism to ensure that the cylinder tank retention mechanism will not be permitted to be lowered without positive operator intervention. Thus, self-braking hand winches, electric winches with automatic braking, and/or hydraulic winches having integral braking are suitable and preferred methodologies of accomplishing this functionality, but not limitive of the scope of the invention.

### Elevation Guide Rails/Platform Fork Angle (0400)

As generally illustrated in FIG. 4 (0400), the present invention anticipates that the angle (0401) between the elevation guide rails and platform forks may be varied. Several embodiments of the present invention anticipate the use of an approximate right angle in this application (90 degrees), whereas in some applications angles between 90 and 100 degrees are anticipated as optimal.

The rationale for this angle selection is to ensure the overall stability of the cylinder cart as the cylinder tank is raised above ground level. In some circumstances the cylinder cart with cylinder tank loaded would have a center of gravity such that the tank would tend to lean forward, creating an unstable platform. In these circumstances, by increasing the angle between the elevation guide rails and platform forks the cylinder cart will remain stable even when the cylinder tank is fully elevated.

### Tire Placement (0400)

As illustrated in the detail drawing of FIG. 4 (0400), the preferred placement of the tire/wheel (0105) is proximal to the surface plane of the ground (0402). This orientation permits the tire/wheel assembly to act as additional support for the stabilizing platform, especially in situations where the optional integrated safety braking system is implemented to ensure that the wheels are locked when the cylinder tank is elevated.

However, some preferred embodiments may raise the tire/wheel assembly slightly above the surface plane of the ground (0402) to ensure that the wheel assembly will not permit movement of the stabilizing platform under circumstances in which the ground is highly irregular or rough. To affect construction of this embodiment, the outer circumference of the tire/wheel assembly (0105) is designed to be above the surface plane of the stabilizing platform floor forks (0201).

### Tire Selection (0500, 0600)

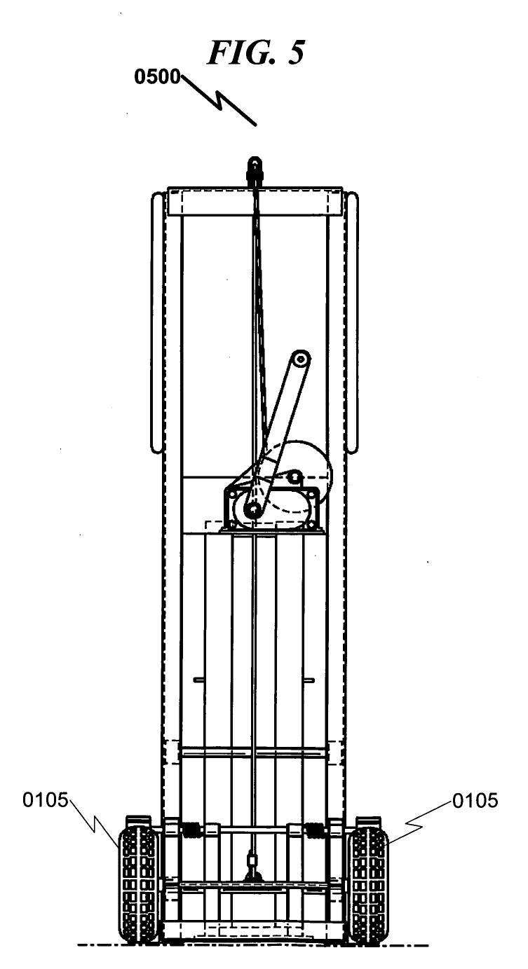

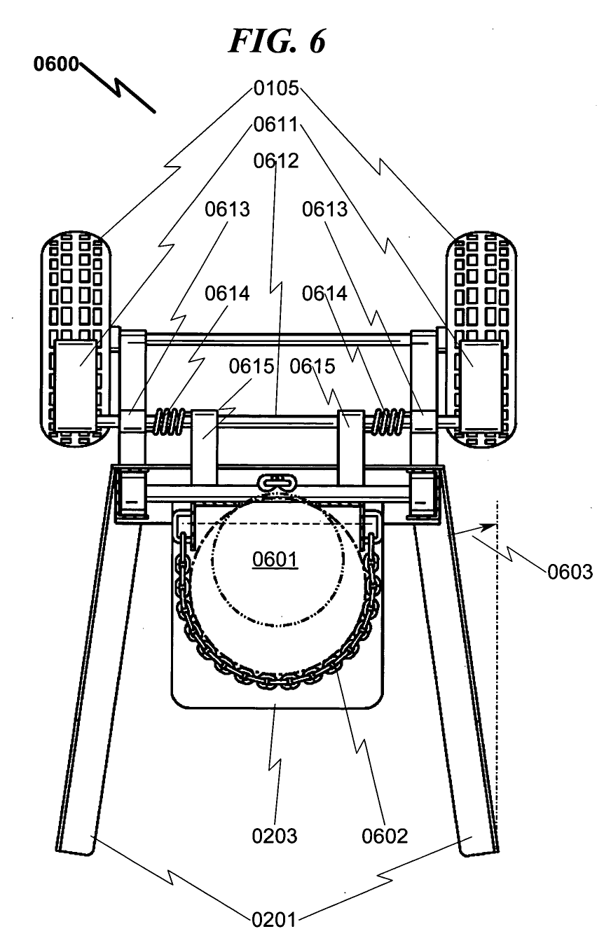

As illustrated in the detail drawings of FIG. 5 (0500) and FIG. 6 (0600), the preferred tires/wheels to be used in the construction of the instant invention are those incorporating all-terrain tires or their equivalent, with pneumatic all-terrain tires being preferred in many embodiments. Given the rough terrain to be encountered in many typical applications such as electric power substations, it is imperative that large, wide, wheels/tires be utilized to prevent sinking of the cylinder cart in the soft ground environment encountered in these applications.

### Cylinder Tank Retention Mechanism (0600)

As illustrated in FIG. 6 (0600), the cylinder tank platform (0203) may support a variety of cylinder tank diameters/sizes (0601), each being restrained via the use of a chain (0602) or some other retention methodology. The present invention anticipates a wide variety of tank retention mechanisms, including chain, straps, rope, etc.

### Stabilizing Platform Floor Forks (0600)

As illustrated in FIG. 6 (0600), the stabilizing platform floor forks (0201) are optimally spread at an angle (0603) to provide additional stability to the cylinder cart. While the angle (0603) of the spread (“spread angle”) may be as little as zero degrees, optimal embodiments indicate that some spread angle greater than zero is necessary to ensure overall cylinder cart stability when the cylinder tank is raised to its fully elevated position.

### Optional Safety Braking System (0600)

As illustrated in FIG. 6 (0600), many preferred embodiments may incorporate a safety braking system to prevent the wheels/tires from rotating whenever the tank retention mechanism is raised for whatever reason. While many forms of this braking system are possible, many preferred embodiments of the present invention anticipate using a passive braking system which automatically engages whenever the tank retention mechanism is raised. The rationale for this is that any form of active braking system in which the operator must activate the brake incurs the possibility of operator error resulting in the cylinder cart possibly falling or accidentally rolling due to the operator's failure to properly engage the safety brake.

Given that the weight of the cylinder tanks being manipulated by the present invention is more than sufficient to cause serious bodily injury and even death if the cylinder cart is accidentally mobile with an elevated cylinder tank engaged, the addition of the disclosed safety brake system is anticipated in many preferred embodiments.

Referencing FIG. 6 (0600), the safety brake mechanism generally consists of brake pads (0611) which are connected to an articulating axle (0612), which rotates within two axle retaining rings (0613) connected to the stabilizing platform frame. The brake pads engage the wheels/tires by virtue of force provided by one or more coil springs (0614) which in their normal state force engagement of the brake pads to the wheels/tires. However, one or more lever arms (0615) connected to the articulating axle (0612) are oriented to touch the cylinder tank platform (an element of the cylinder tank retention mechanism) when the cylinder tank platform is fully lowered. This contact between the lever arm(s) and the cylinder tank platform places resistive force against the coil springs (0614) and thus disengages the brake pads (0611) from the wheels only when the cylinder tank platform is fully lowered.

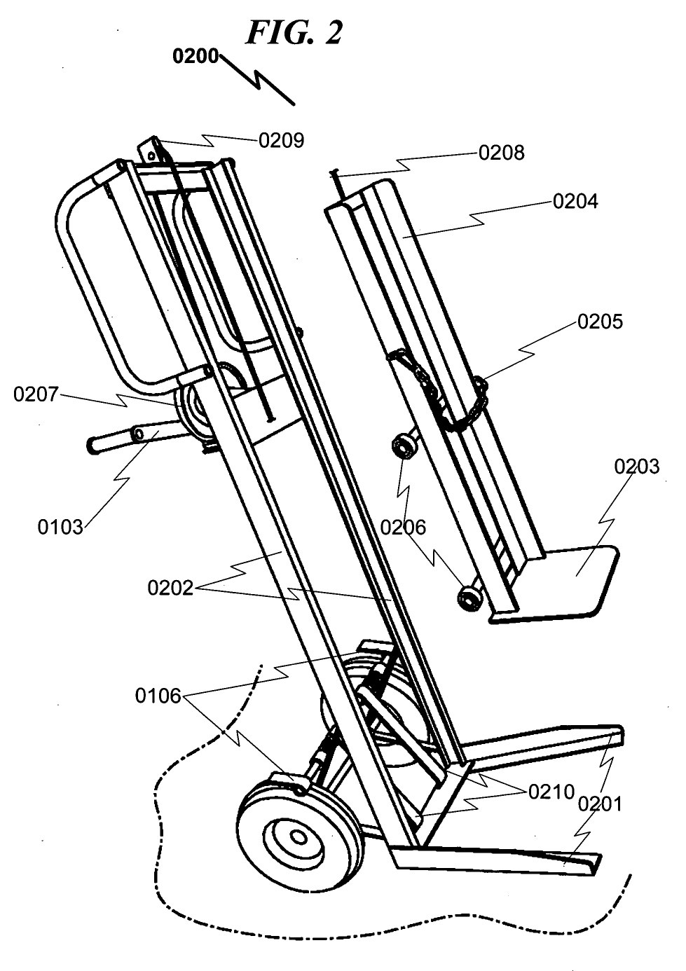

FIG. 2 (0200) and FIG. 4 (0400) provide oblique and side views of the present invention and generally illustrate the operation of the brake pads and lever arm(s) in relation to the cylinder tank platform. Other embodiments anticipated include configurations where the lever arm(s) make contact with some element of the frame of the cylinder tank retention mechanism to affect the engagement/disengagement of the brake pads with the wheels/tires of the cylinder cart. One skilled in the art will recognize that the lever arm(s) may be configured in a variety of ways to accomplish the automatic safety brake.

### System Variations

The present invention anticipates a wide variety of variations in the basic theme of construction. The examples presented previously do not represent the entire scope of possible usages. They are meant to cite a few of the almost limitless possibilities.

### Operation (0700, 0800, 0900)

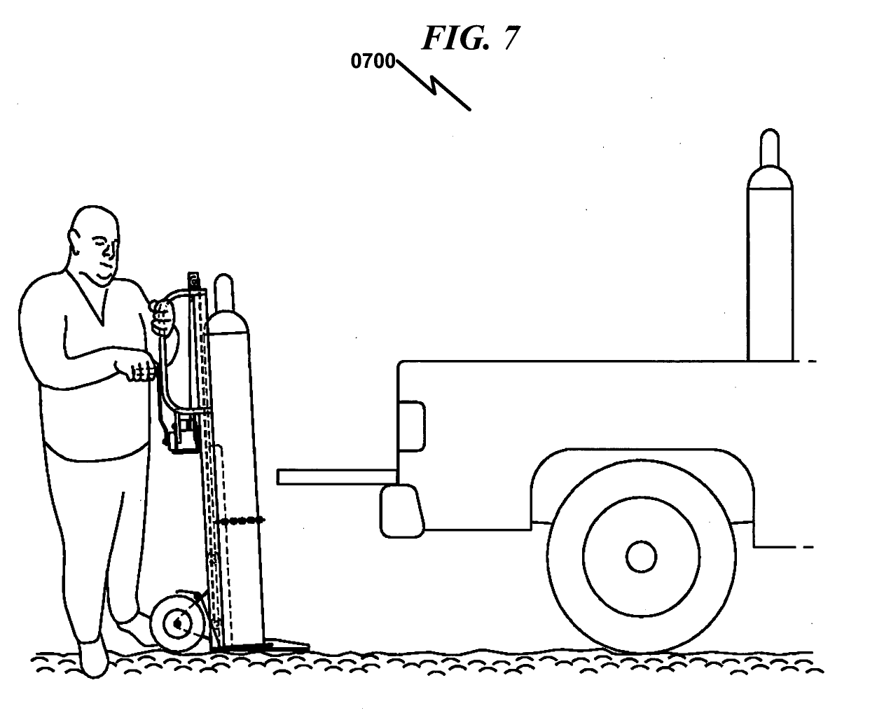

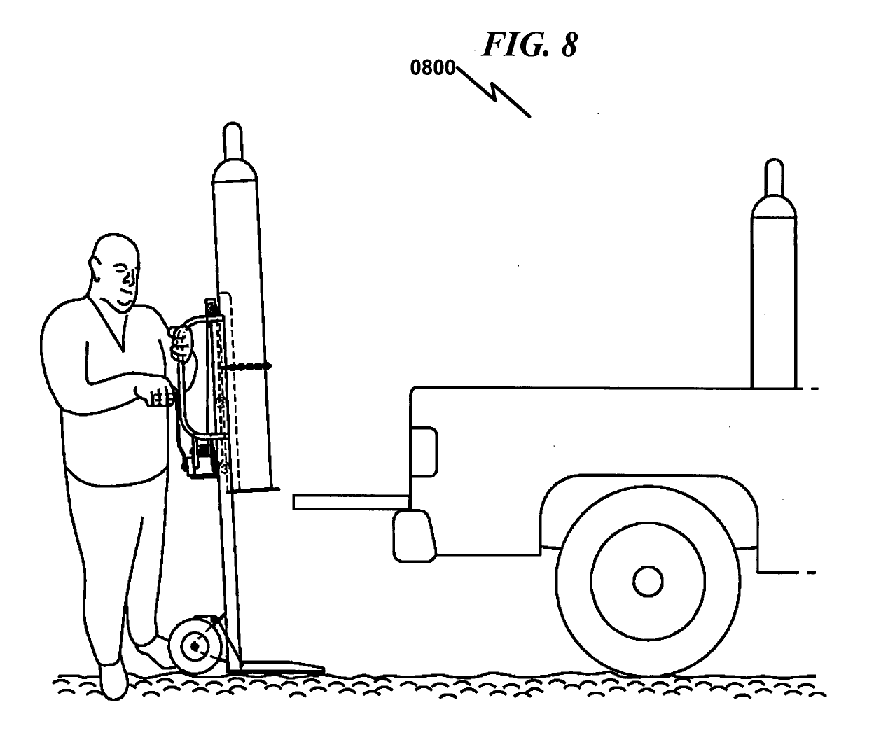

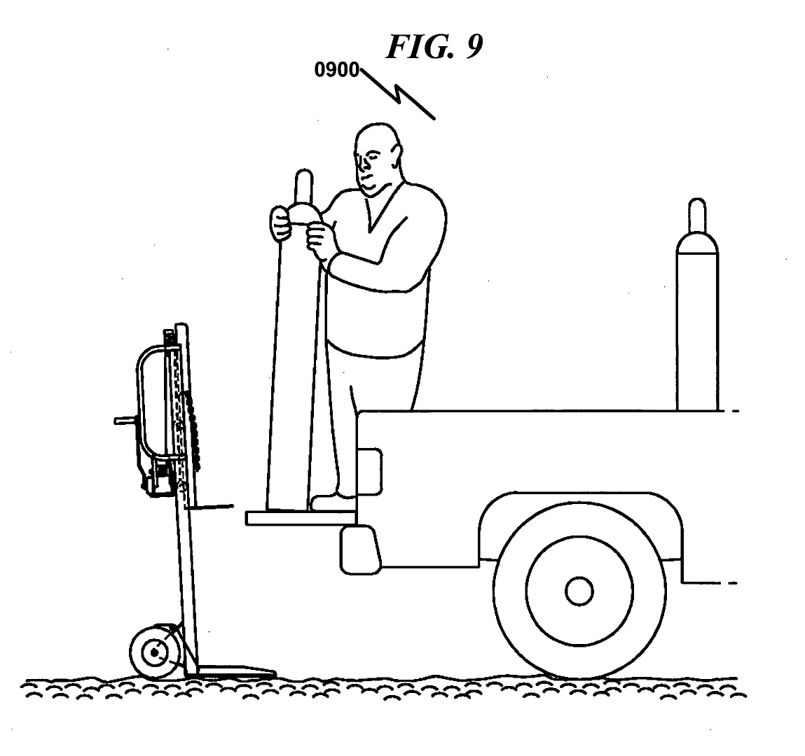

The present invention anticipates a wide variety of operational variations. However, one preferred exemplary operational scenario is generally illustrated in FIG.7 (0700), FIG. 8 (0800), and FIG. 9 (0900). As illustrated in FIG. 7 (0700), the operator has restrained a cylinder tank to the cylinder cart and rolled same to the edge of a pickup truck. As generally illustrated in FIG. 8 (0800), the next step is to raise the cylinder tank to the level of the pickup truck bed via the use of a hand winch or other integrated elevator mechanism. Once the cylinder tank is properly raised, it may be disengaged from the cylinder cart and safely rolled onto the bed of the pickup truck as generally illustrated in FIG. 9 (0900).

It is significant to note in the foregoing example that at no time has the operator had to lift or manipulate the cylinder tank in a manner which would be injurious to the operator's back. This is important given the weight of the cylinder tank and the propensity for operator back injuries when attempting to lift objects of this weight in this application environment. Additionally, note that under no circumstances is the cylinder tank unrestrained in a manner which would be considered unsafe given the possibility and danger of tank rupture should a cylinder tank fall and incur a valve dislocation.

### CONCLUSION

A cylinder cart system that incorporates a stabilizing platform for safely loading and offloading of gas/fluid cylinders from trucks and the like has been disclosed. The cylinder cart system incorporates a stabilizing platform to which a tank retention mechanism is attached that permits a gas/fluid cylinder to be retrained and raised/lowered via the use of an integrated elevator mechanism that may be manually or power operated. In the raised position, the cylinder cart provides sufficient stability to permit safe offloading of a gas/fluid cylinder onto a pickup truck or the like by a single person. In the lowered position, the cylinder cart incorporates hand truck functionality to permit transport of the gas/fluid cylinder across rugged terrain. An optional integrated safety braking system may in some embodiments provide additional stabilization of the system when the cylinder cart is in the raised position.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A cylinder cart system comprising:
(a) stabilizing platform further comprising elevation guide rails and platform forks;
(b) tank retention mechanism further comprising tank platform, tank retention rails, tank retention chain, and guide rollers;
(c) integrated elevator mechanism further comprising a lifting mechanism, pulley, and cable assembly;
(d) hand rails; and
(e) all terrain tires;
wherein
said guide rollers in said tank retention mechanism permit said tank retention mechanism to rest within and be constrained by said elevation guide rails of said stabilizing platform, permitting said tank retention mechanism to be elevated or lowered by said integrated elevator mechanism;
said lifting mechanism is connected to said cable assembly which traverses said pulley and is connected to said tank retention mechanism;
said hand rails are connected to the distal end of said elevation guide rails;
said platform forks form a plane with respect to the ground; and
said all terrain tires are connected via an axle to said stabilizing platform such that the circumference of said tires are proximal to said plane formed by said platform forks.

2. The cylinder cart system of claim 1 wherein said integrated elevator mechanism further comprises a hand winch.

3. The cylinder cart system of claim 1 wherein said integrated elevator mechanism further comprises an electric winch.

4. The cylinder cart system of claim 1 wherein the angle between said elevation guide rails and platform forks is 90 degrees;

5. The cylinder cart system of claim 1 wherein the angle between said elevation guide rails and platform forks is greater than 90 degrees but less than 100 degrees;

6. The cylinder cart system of claim 1 wherein the outer circumference of said tires is coincident with the plane formed by said platform forks.

7. The cylinder cart system of claim 1 wherein the outer circumference of said tires is above the plane formed by said platform forks.

8. The cylinder cart system of claim 1 wherein said platform forks form a spread angle greater than zero degrees.

9. The cylinder cart system of claim 1 wherein said stabilizing platform further comprises 6061-T6 aluminum alloy.

10. The cylinder cart system of claim 1 wherein said all-terrain tires are pneumatic.

11. A cylinder cart system comprising:
(a) stabilizing platform further comprising elevation guide rails and platform forks;
(b) tank retention mechanism further comprising tank platform, tank retention rails, tank retention chain, and guide rollers;
(c) integrated elevator mechanism further comprising a lifting mechanism, pulley, and cable assembly;
(d) hand rails;
(e) all terrain tires; and
(f) safety braking mechanism, further comprising wheel brakes, articulating axle, lever arm, and coil spring;
wherein said guide rollers in said tank retention mechanism permit said tank retention mechanism to rest within and be constrained by said elevation guide rails of said stabilizing platform, permitting said tank retention mechanism to be elevated or lowered by said integrated elevator mechanism;
said lifting mechanism is connected to said cable assembly which traverses said pulley and is connected to said tank retention mechanism;
said hand rails are connected to the distal end of said elevation guide rails;
said platform forks form a plane with respect to the ground;
said all terrain tires are connected via an axle to said stabilizing platform such that the circumference of said tires are proximal to said plane formed by said platform forks; and
said safety braking mechanism engages to said tires said wheel brakes that are attached to said articulating axle in response to said lever arm being engaged by said coil spring when said tank platform is elevated.

12. The cylinder cart system of claim 11 wherein said integrated elevator mechanism further comprises a hand winch.

13. The cylinder cart system of claim 11 wherein said integrated elevator mechanism further comprises an electric winch.

14. The cylinder cart system of claim 11 wherein the angle between said elevation guide rails and platform forks is 90 degrees;

15. The cylinder cart system of claim 11 wherein the angle between said elevation guide rails and platform forks is greater than 90 degrees but less than 100 degrees;

16. The cylinder cart system of claim 11 wherein the outer circumference of said tires is coincident with the plane formed by said platform forks.

17. The cylinder cart system of claim 11 wherein the outer circumference of said tires is above the plane formed by said platform forks.

18. The cylinder cart system of claim 11 wherein said platform forks form a spread angle greater than zero degrees.

19. The cylinder cart system of claim 11 wherein said stabilizing platform further comprises 6061-T6 aluminum alloy.

20. The cylinder cart system of claim 11 wherein said all-terrain tires are pneumatic.
